(19) United States
(12) Patent Application Publication
(10) Pub. No.: US 2003/0168236 A1
(43) Pub. Date: Sep. 11, 2003

(54) Cable tidy

(76) Inventor: Neville Simeon Conrad, London (GB)

Correspondence Address: Jay F Moldovanyi, Fay Sharpe Fagan Minnich & McKee, 7th Floor, 1100 Superior Avenue, Cleveland, OH, 44114-2518, US

(21) Appl. No.: 10/312,972

(22) PCT Filed: Apr. 27, 2001
(86) PCT No.: PCT/GB01/01893

(30) Foreign Application Priority Data
Jun. 30, 2000 (GB) 0016252.9

(51) Int. Cl. H01H 9/02

(52) U.S. Cl. 174/53

(57) ABSTRACT

A housing for a multiway electrical adapter, the housing comprising a generally tubular body (2, 6) having are movable cap (16, 18) at least at one end, and at least one cable exit aperture (22, 14) formed at the junction of the or each cap and the body so that the adapter can be placed inside the body with a cable or cables protruding from the end, before the cap is placed in position.

This invention relates to a device for housing a multiway electrical adapter, and particularly to a housing device for multiway adapters together with surplus cable attached to plugs which are plugged into the adapter. It is particularly, though not exclusively intended for use with mains adapters

According to the present invention there is provided a housing for a multiway electrical adapter, the housing comprising a generally tubular body having a removable cap at least at one end, and at least one cable exit aperture formed at the junction of the or each cap and the body so that the adapter can be placed inside the body with a cable or cables protruding from the end, before the cap is placed in position.

Preferably, the body is telescopic so as to accommodate adapters of different lengths, and also any surplus cable.

Preferably the or each cable exit aperture is formed as a cutaway portion at the mating edge of the cap or the body or both.

Preferably, the body has removable end caps at both ends, so that a power supply or input cable can pass through a cable exit at one end, whilst output cables pass through an exit at the other end.

Preferably, the body is provided with at feast one suspension member such as a swivelling hook or loop, at least at one end of the body, so as to enable it to be suspended from a suitable supporting device, such as another co-operating hook. Preferably, the suspension member has a flexible body at least one end of which is secured in an aperture in the body of the housing, whilst the protruding part forms a loop for attachment to the co-operating supporting device.

In one embodiment the housing has a stud or socket on its inside wall adjacent the aperture to which the suspension member is attached by means of a co-operating socket or stud.

Preferably, the device further comprises at least one separate supporting device consisting of a hook to co-operate with the loop, and a clamp or other suitable connecting means adapted to fit onto the edge of the surface of a desk or table.

In a preferred embodiment of the invention, the housing is provided with a pair of suspension members, which pass through separate apertures so that the body can be suspended in either a horizontal or a vertical orientation.

One embodiment of the invention will now be described by way of example, with reference to the accompanying drawings in which:

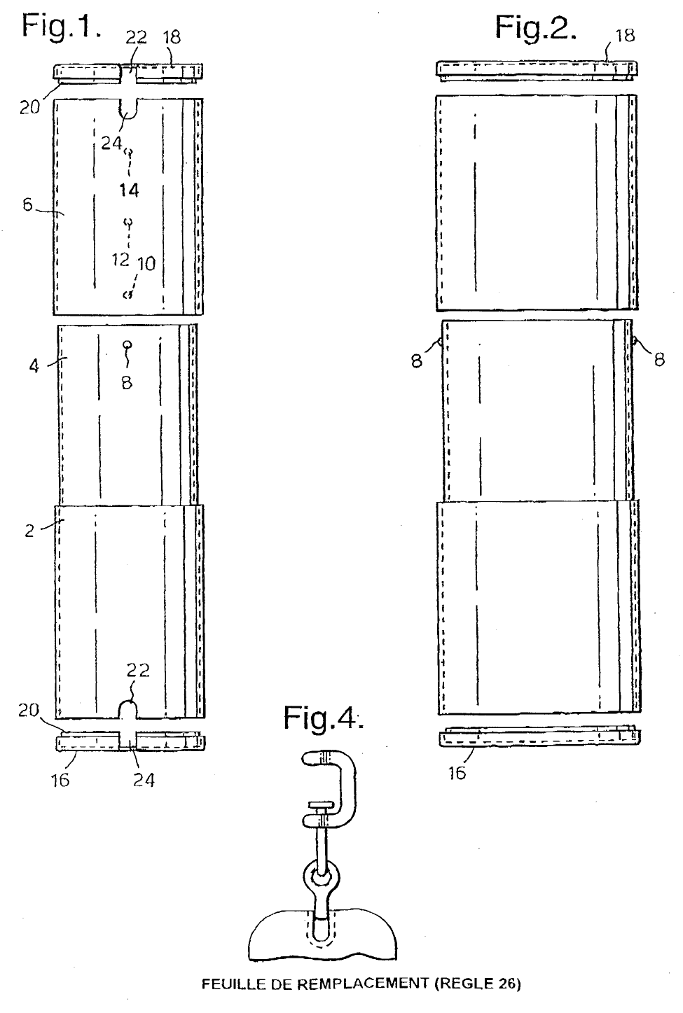

FIG. 1 is a partly disassembled side elevation view of a device according to the invention;

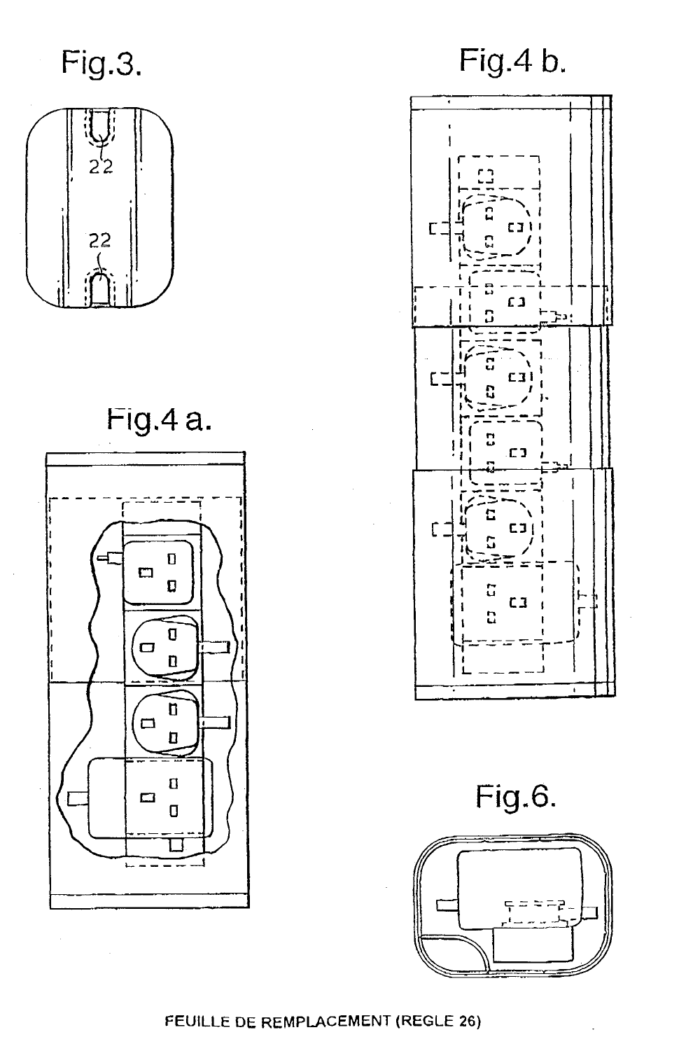

FIG. 2 is a side elevation taken at right angles to the view of FIG. 1; FIG. 3 is an end view;

FIGS. 4a and 4b are assembled views corresponding to the elevation of FIG. 2;

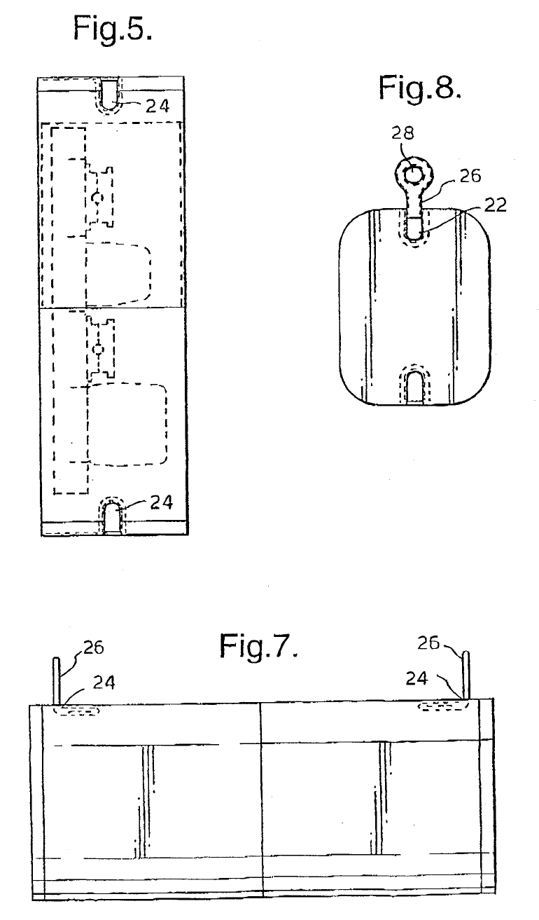

FIG. 5 is an assembled view in an alternative configuration;

FIG. 6 is an end view with the end of the device open;

FIG. 7 illustrates a first, horizontal suspension mode of the device;

FIG. 8 is an end view of the arrangement of FIG. 7;

FIG. 9 shows an alternative, vertical suspension;

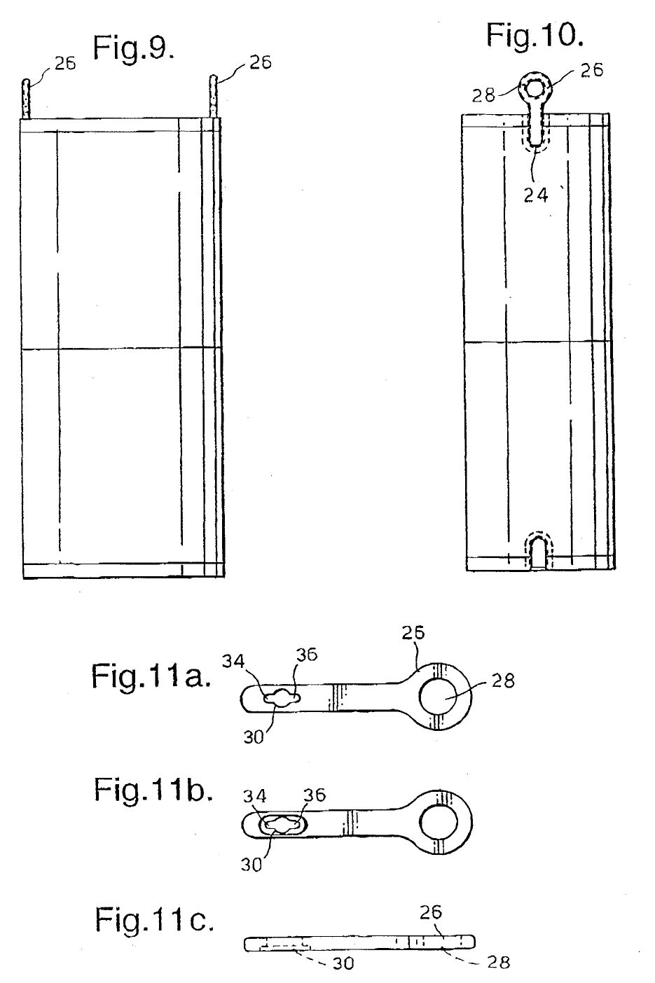

FIG. 10 shows a side elevation of the view of FIG. 9,

FIGS. 11a, 11b, and 11c are respectively, a plan view, an underneath plan view, and a side view of a suspension hook;

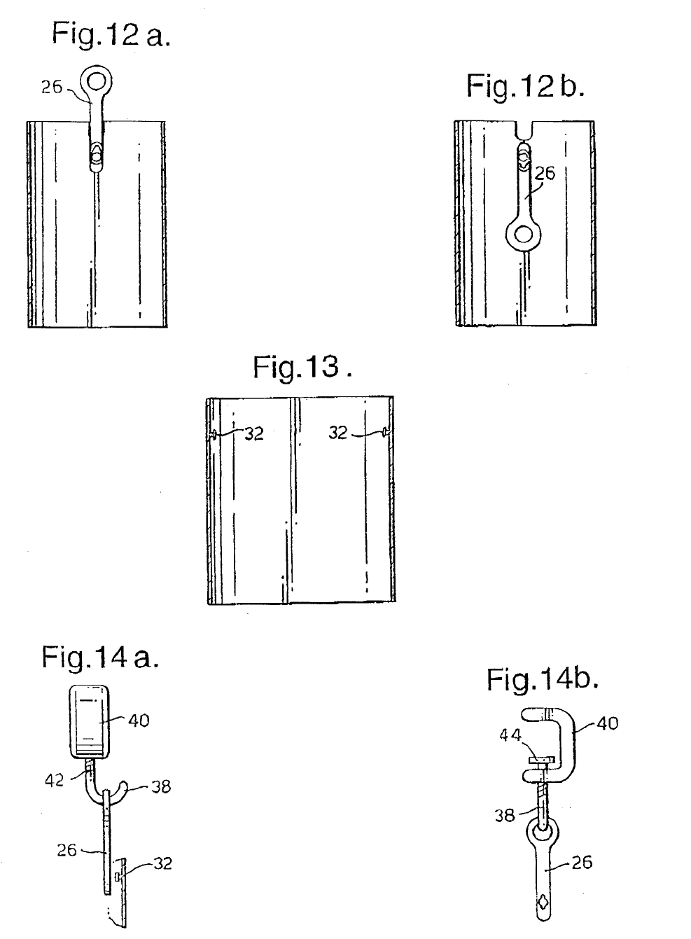

FIGS. 12a and 12b show the positions of the suspension hook respectively in a deployed and retracted mode;

FIG. 13 shows the position of locating studs for suspension hooks, in the body of the device;

FIGS. 14aand 14b respectively show mutually perpendicular side elevations of a suspension device supporting a hook of the kind shown in FIG. 11;

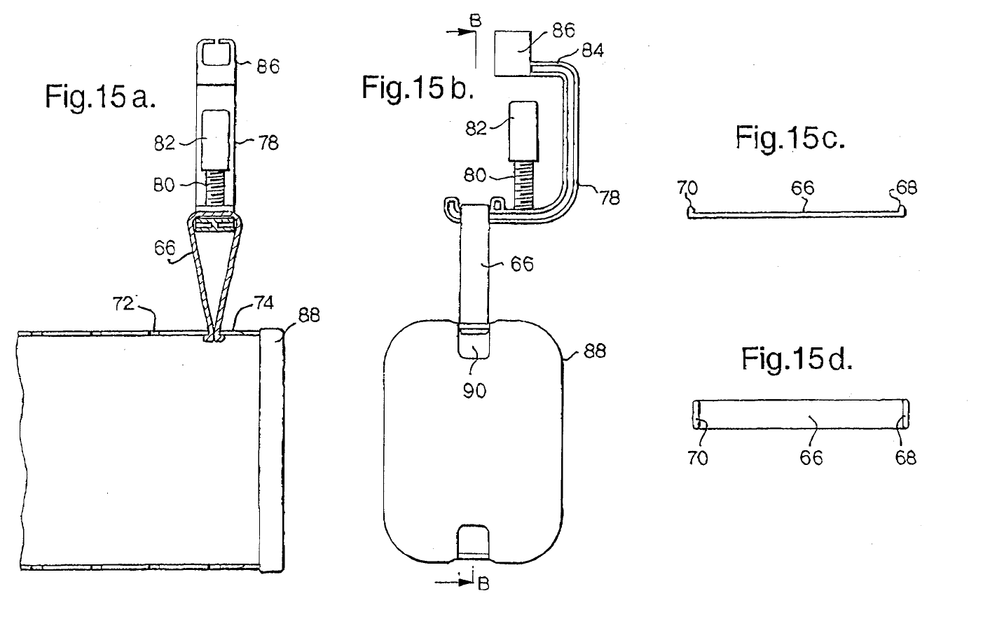

FIG. 15a shows a partial cross-section through one end of an alternative form of the device and its suspension system;

FIG. 15b is a cross section on the line B-B of the device of FIG. 15a;

FIG. 15c is an edge view of a suspension strap;

FIG. 15d is a plan view of the strap of FIG. 15c.

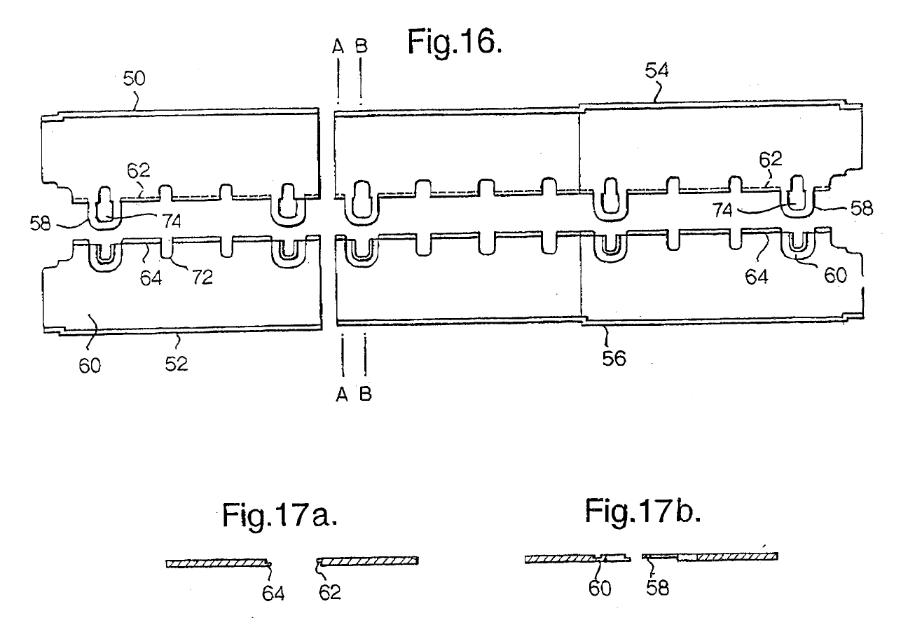

FIG. 16 is a disassembled axial cross section through the enclosure of FIGS. 15a-b;

FIG. 17a is a cross-section of a side wall taken along the line B-B of FIG. 16; and

FIG. 17b is a cross-section of a side wall taken along the line B-B of FIG. 16.

Referring to the drawings, and particularly to FIGS. 1 and 2, the cable adapter housing comprises a telescopic tubular body of generally rectangular cross-section. The body comprises two sections, a first part 2 as shown in FIG. 1, having an upper section 4, of reduced cross section, and a second part 6 in the form of a sleeve which is adapted to slide over the reduced cross section part 4. Locating studs 8 are provided on opposite sides of the reduced section 4, as shown in FIG. 2, which are adapted to cooperate with corresponding recesses 10, 12, 14, spaced along the inside surface of sleeve member 6, so that the device can be closed up to a desired length, as explained in detail below.

End caps 16, 18, are provided for the opposite ends of the body, each having a peripheral flange 20, of a suitable size to snap into the corresponding end of the body. A cable exit aperture at each end of the body is formed by corresponding cut-aways 22 and 24 respectively provided in the end of the sleeve, and the side edge of the end cap, so that when the end caps are positioned on the device, a single aperture is provided in each position, as can be seen in the assembled side elevation of FIG. 5.

It will also be appreciated, that as illustrated in FIG. 3, corresponding exit holes are provided in this way on each side of the device, at each end, so that there will be four apertures altogether.

In use, a multiway adapter is positioned inside the device, as illustrated (for example) in FIGS. 4a or 4b, before the end caps are placed in position. As will be appreciated from a comparison of these two Figures, the telescopic arrangement allows the length of the device to be adjusted, to suit the size of the internal adapter, and the arrangement of the cable exit holes enables cables to be appropriately positioned, before the end caps are snapped into place, so as to locate them securely. The internal capacity of the device is also such that space can be allowed for storage of any surplus cable, so that only the required length is allowed to project through the exit holes. The device is also provided with a suspension arrangement, so that it can be suspended, for example from the edge of a desk, once the adapter has been located inside.

FIG. 7 shows the position of the device when it is suspended horizontally, using a pair of suspension loops 26 which extend out through the cable exit holes, in this case, at opposite ends of the body. As can be seen from the corresponding end view of FIG. 8, each suspension loop 26 is provided with an aperture 28 to hang on a hook, as described in more detail below. The body of the loop 26 is flexible, so that it can extend out vertically through the cable exit holes, in a vertical direction, regardless of whether the device is to be suspended in a horizontal position as indicated in FIG. 7, or in the alternative vertical position as illustrated in FIGS. 9 and 10.

The suspension loop 26 is illustrated in more detail in FIGS. 11a to 11c, from which it will be seen that the inner end of the flexible body 26, opposite to the suspension aperture 28, carries a bayonet shaped aperture 30, which is adapted to fit over a stud 32 inside the end of the body of the device. FIG. 13 illustrates the positions of a pair of such studs 32, mutually opposed on opposite sides of the inside of the end of the device, and it will be seen that each stud has a generally T-shaped cross-section, the head being circular and corresponding in size to the central circular part of the aperture 30 in the end of the suspension loop 26. The bayonet configuration of the aperture 30, provides a pair of narrower extension portions 34, 36 projecting in opposite directions, so that the suspension loop 26 can be attached to the stud 32 by slipping the central part of the aperture 30 over the top of the stud, and the outer end of the suspension loop can then be pulled out through the cable exit hole to the suspension position illustrated in FIG. 12a. The narrower extension portion 34 of aperture 30 then fits over the neck of stud 30. Alternatively, when the loop is not in use, it can be pulled back in the opposite direction so as to retract inside the body to the position illustrated in FIG. 12b.

A suspension device for supporting the loop 26 comprising a hook 38 attached to a G clamp 40 is illustrated in FIGS. 14a and 14b. It comprises a hook 38 attached to a G clamp 40, the hook part 38 thus providing a suitable suspension point for the loop 26. The upwardly extending leg of the hook 38 is screw threaded, as indicated at 42, and passes through a threaded aperture in the base of the clamp member 40, terminating in an enlarged head 44, so that the device can be screwed onto the edge of a desk or a table.

An alternative form of the device illustrated in FIGS. 15-17 is formed from pairs of half-shells 50, 51 and 54, 56 (FIG. 16) which are designed to snap together to form two telescoping sections corresponding to those of FIGS. 1 and 2. The connections between the half-shells each comprise a hoop-shaped snap member 58 extending from the edge of one half-shell and a corresponding U-shaped recess 60 formed on the inside surface of the wail of the other half-shell. When the two half-shells are brought together, therefore, the hoop shaped projection 58 will be nested in the recess 60 by virtue of their complementary cross sections (see FIG. 17b). At the same time, complementary stepped formations 62, 64 on the edges of the half-shells (FIGS. 16 and 17a) engage with one another to securely position the adjacent edges.

Referring to FIG. 15, a strap suspension system is provided for the device of FIG. 16 which comprises a flexible hanging strap 66 having projecting feet 68, 70 at each end so that the strap can be folded over and its ends inserted into a suitable slot formed in the side of the body of the device. It will be appreciated that this slot could be the central aperture 74 of one of the hooped snap fittings 58-60, or one of the alternative apertures 72 formed along the length of the body.

As will be clear from FIGS. 15a and 15b, when the ends of the strap 66 are suitably fitted into the aperture 74, the strap forms a loop which can be suspended on a suitable hook-like member 76. As shown in FIG. 15b, this forms the lower leg of a C clamp body 78 having an internal threaded pillar 80 carrying an adjustment member 82 which can be rotated to clamp onto the edge of a supporting surface (not shown) located between the adjustment member 82 and the upper arm 84 of the clamp.

The upper arm 84 also carries a flexible cable guide 86 for locating cables which are to be connected into the device. Thus when a pair of the clamps 78 are attached to the rear edge of a desk (for example) at a suitable spacing, with the cable enclosure suspended beneath them, cables from electrical devices on the desk can be secured at the rear edge by first running them through the channels of the guide members 86, and then over the edge into the enclosure 88 through the adjacent entry/exit apertures 90.

1. A housing for a multiway electrical adapter, the housing comprising a generally tubular body (2, 6) having a removable cap (16, 18) at least at one end, and at least one cable exit aperture (22, 14) formed at the junction of the or each cap and the body so that the adapter can be placed inside the body with a cable or cables protruding from the end, before the cap is placed in position.

2. A housing for a multiway electrical adapter according to claim 1 in which the body is telescopic so as to accommodate adapters of different lengths, and also any surplus cable.

3. A housing for a multiway electrical adapter according to claim 1 or claim 2 in which the or each cable exit aperture is formed as a cutaway portion at the mating edge of the cap or the body or both.

4. A housing for a multiway electrical adapter according to any of claims 1 to 3 in which the body has removable end caps at both ends, so that a power supply or input cable can pass through a cable exit at one end, whilst output cables pass through an exit at the other end.

5. A housing for a multiway electrical adapter according to any of claims 1 to 4 in which the body is provided with a hook or loop suspension member at least at one end, so as to enable it to be suspended from a suitable supporting device, such as another co-operating hook.

6. A housing for a multiway electrical adapter according to claim 5 in which the suspension member has a flexible body, one end of which passes through an aperture in the body of the housing, and is attached to the inside wall of the body, whilst the protruding end is formed with a loop for attachment to the co-operating supporting device.

7. A housing for a multiway electrical adapter according to claim 6 in which the housing has a stud or socket on its inside wall to which the suspension member is attached by means of a co-operating socket or stud.

8. A housing according to claim 6 or claim 7 in which the suspension member is arranged to pass through one of the cable exit apertures.

9. A housing for a multiway electrical adapter according to claim 5 in which the suspension member comprises an elongate flexible strap member whose ends are adapted to be retained in an aperture or apertures in the body, so as to form a loop between them.

10. A housing for a multiway electrical adapter according to claim 9 in which the ends of the strap member are formed with enlarged portions which are adapted to be flexed for insertion into the apertures of the body.

11. A supporting device for use with a housing for a multiway electrical adapter according to any of claims 5 to 10, the supporting device comprising a hook to co-operate with the suspension member, and a clamp or other suitable connecting means adapted to fit onto the edge of the surface of a desk or table.

12. A supporting device according to claim 11 in which the clamp comprises an upper arm and a lower arm, one of which is provided with an extendable screw member whereby the edge of a surface can be clamped between them.

13. A supporting device according to claim 12 further comprising a cable guide member mounted on the upper arm.

14. A housing for a multiway electrical adapter according to any of claims 1 to 10 including a pair of suspension members and a corresponding pair of supporting devices according to any one of claims 11 to 13.

15. A housing for a multiway electrical adapter substantially as herein described with reference to the accompanying drawings.
